(19) United States
(12) Patent Application Publication
(10) Pub. No.: US 2012/0242450 A1
(43) Pub. Date: Sep. 27, 2012

(54) Communication System and Method

(76) Inventor: Simon Brohez, Namur (BE)

(21) Appl. No.: 13/425,696

(22) Filed: Mar. 21, 2012

Related U.S. Application Data
(60) Provisional application No. 61/466,422, filed on Mar. 22, 2011.
(60) Provisional application No. 61/466,429, filed on Mar. 22, 2011.

(51) Int. Cl. G06F 13/42

(52) U.S. Cl. 340/1.1

(57) ABSTRACT

A device is provided that includes a network communication portion, a device communication portion, a registration portion and a controller portion. The network communication portion can communicate with a communication network. The device communication portion can communicate with a second communication device, can communicate with a third communication device, can receive a registration communication and can receive a first communication. The registration portion can associate the third communication device with the second communication device based on the registration communication. The controller portion can instruct the device communication portion to transmit a first communication to the second communication device.

The present application claims priority from U.S. Provisional Application No. 61/466,422 filed Mar. 22, 2011, and U.S. Provisional Application No. 61/466,429 filed Mar. 22, 2011, the entire disclosures of which are incorporated herein by reference.

### BACKGROUND

The present invention relates to communication systems.

There are many ways to contact someone: home phone, work phone, cell phone email accounts, facsimile machine, etc. If Bob wants to speak with Joe, Bob guesses how best to reach him. Bob might first call Joe's home phone. If Joe does not answer the home phone, Bob might next try Joe's cell phone. This could continue until either Bob gets through to Joe or Bob runs out of numbers. Not only is this time-consuming, it requires Bob to maintain sets of numbers for each of his friends and other contacts.

A communication system has been developed to streamline electronic communication between people who have many contacts. This system, which assigns a dedicated portal for each contact, will now be described in greater detail with reference to FIG. 1.

FIG. 1 illustrates such a conventional communication system.

As shown in the figure, communication system 100 includes a communication network 102. A plurality of users, represented as users 110, 112 and 114 connect to communication system 102 via a plurality of portals, indicated here as portals 104, 106 and 108.

Communication system 100 includes public switch telephone network (PSTN) 116, satellite network 118, Internet 120 and cellular network 122.

User 110 includes devices 124 (in this example, a home phone) and 126 (in this example, a cellular phone). User 112 includes devices 128 (in this example, a home phone), 130 (in this example, a cellular phone), and 132 (in this example, an e-mail address). User 114 includes devices 134 (in this example, an office phone) and 136 (in this example, a cellular phone).

PSTN 116 is able to communicate with cellular network 122, satellite network 118 and internet 120. Internet 120 is able to communicate with satellite network 118 and cellular network 122. Cellular network 122 is able to communicate with satellite network 118. Each of PSTN 116, cellular network 122, satellite network 118 and internet 120 is able to communicate with portals 104, 106 and 108. So briefly, portals 104, 106 and 108 are able to communicate with communication system 102 by communicating with any of the networks within it.

Portal 104 can bidirectionally communicate with devices 124 and 126, portal 106 can bidirectionally communicate with devices 128, 130 and 132, and portal 108 can bidirectionally communicate with devices 134 and 136. Portals 104, 106 and 108 can also bidirectionally communicate with communication network 102.

PSTN 116 includes telephone lines, copper and fiber optic cables, microwave transmission links and undersea telephone cables, all interconnected by switching centers, thus allowing any telephone in the world to communicate with any other.

Satellite network 118 is a system of transceivers operating on assigned frequencies, either fixed in space (on geosynchronous satellites) or in orbit around the earth (on low earth orbit satellites).

Internet 120 is a global system of computer networks, consisting of private, public, academic, business and government networks connected by various electronic, wireless and optical networking technologies.

Cellular network 122 is a radio network distributed over land areas called cells, and when joined together these cells provide radio coverage over a wide geographic area. This enables a large number of portable devices (mobile phones, pagers, etc.) to communicate with each other and with fixed devices and telephones anywhere in the network.

Portals are gateways for individual users. Users 110, 112 and 114 must connect via portals 104, 106 or 108, in order to be routed to one of the networks within communication network 102.

In order to connect with their assigned portal 104, 106, or 108, users 110, 112, or 114 must utilize devices 124-136. Devices 124-136 may be a land-line telephone, cellular telephone, satellite telephone, pager, computer, etc.

Again, consider the situation where Bob wants to speak with Joe. With communication system 100, Bob merely needs to contact Joe's portal. For example, assume Bob is user 110, and Joe is user 114.

In operation, user 110 may want to use device 126 (in this case, Bob's cellular phone) to contact device 134 of user 114 (in this case, Joe's land-line phone). User 110 would use device 126 to connect, via portal 104, with cellular network 122 of communication network 102. The call would then be routed from cellular network 122 to PSTN 116, then from PSTN 116 to portal 108. From portal 108, the call would then be routed to device 134 of user 114 to complete the connection.

In some prior art systems, portals 104, 106, and 108 include a unique identifier. For example, the unique identifier may be a telephone number. In these systems, in order for user 110 to use device 126 to contact device 134 of user 114, user 110 must know the unique identifier associated with portal 108. Therefore, in addition to knowing the number of device 134, in order for user 110 to contact user 114 he must know the contact number of portal 108, and first make a connection with portal 108 before connecting with device 134.

In another conventional communication system, calls may be redirected to another device. This type of “call forwarding” is independent of the context of the call: whether the caller receives no answer from the user, the line is busy, the user has no network coverage, or the user has chosen to forward all calls even though the user may be available, the call is forwarded from the device originally called to a secondary device. This may not be useful if the incoming communication is text or video data.

What is needed is a system and method for providing a single portal through which communications are routed, thus simplifying the connection process described above.

### BRIEF SUMMARY

The present invention provides a system and method for providing a single portal through which communications are routed, thus simplifying the connection process in a communication system.

In accordance with an aspect of the present invention, a device is provided for use with a first communication device of a first user, a second communication device of a second user, a third communication device of the second user, a communication network and a registration communication. The first communication device can transmit a first communication to the third communication device by way of the communication network. The third communication device can receive the first communication from the communication network. The registration communication is based on the third communication device. The third communication device can further transmit the first communication. The device includes a network communication portion, a device communication portion, a registration portion and a controller portion. The network communication portion can communicate with the communication network. The device communication portion can communicate with the second communication device, can communicate with the third communication device, can receive the registration communication and can receive the first communication. The registration portion can associate the third communication device with the second communication device based on the registration communication. The controller portion can instruct the device communication portion to transmit the first communication to the second communication device.

Additional advantages and novel features of the invention are set forth in part in the description which follows, or will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a conventional communication system;

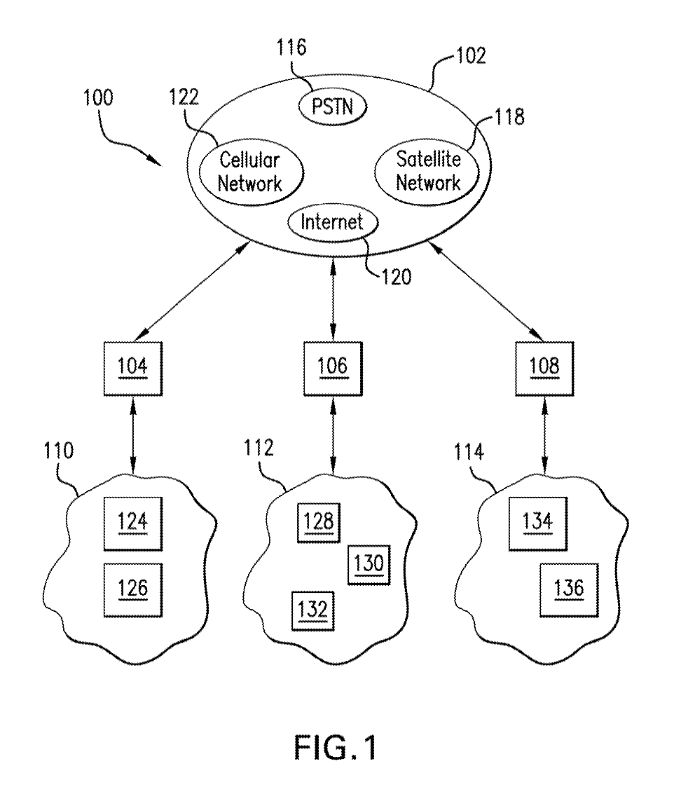

FIG. 2 illustrates a Centralized Communication Management System (CCMS) in accordance with aspects of the present invention;

FIG. 3 illustrates an exploded view of the CCMS of FIG. 2;

FIG. 4 illustrates a user that communicates via the CCMS of FIG. 3;

FIG. 5 illustrates an attempt to open a connection between another user and the user of FIG. 4;

FIG. 6 illustrates a process by which the CCMS of FIG. 3 determines how to implement the connection of FIG. 5;

FIG. 7 illustrates an attempt to open a connection between the user of FIG. 4 and the user of FIG. 5;

FIG. 8 illustrates a process by which the CCMS of FIG. 3 determines how to rout an attempt to open the connection of FIG. 7;

FIG. 9 illustrates a rejected attempt to open a connection between the user of FIG. 5 and the user of FIG. 4; and

FIG. 10 illustrates a process by which the CCMS of FIG. 3 determines how to deliver the message that the user of FIG. 4 is not available.

### DETAILED DESCRIPTION

The present invention is drawn to a centralized communication management system that provides a single repository of user information. After completing a registration or subscription process, registered users input contact information, contact preferences, address books, availability information and any other information deemed useful by the user. Any communications sent to, or received from, other users registered on the system will be routed through the centralized communication system, based on the information provided to the system by the user.

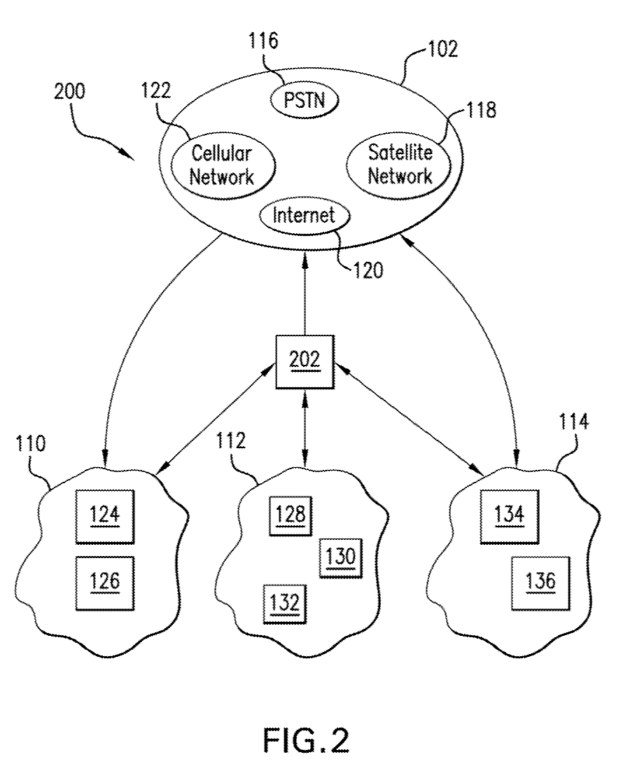

Aspects of the present invention as discussed above will now be further described in greater detail with reference to FIGS. 2-10.

FIG. 2 illustrates a communication system 200 in accordance with aspects of the present invention.

As shown in the figure, communication system 200 includes communication network 102, centralized communication management system (CCMS) 202 and a plurality of users, a sample of which is indicated here as users 110, 112, and 114.

CCMS 202 is arranged to communicate with each of devices 124-136 and with communication network 102.

CCMS 202 serves as a gateway to provide devices 124-136 access to communication network 102. Devices 124-136 must first connect with CCMS 202 in order to be routed to one of the networks within communication network 102.

In operation, user 110 may want to use device 126 (in this case, a cellular phone) to contact device 134 (in this case, a land-line phone) of user 114. User 110 would use device 126 to connect with CCMS 202, which would then connect with cellular network 122 of communication network 102. The call would then be routed from cellular network 122 to PSTN 116, then from PSTN 116 back to CCMS 202. From CCMS 202, the call would then be routed to device 136 of user 114 to complete the connection.

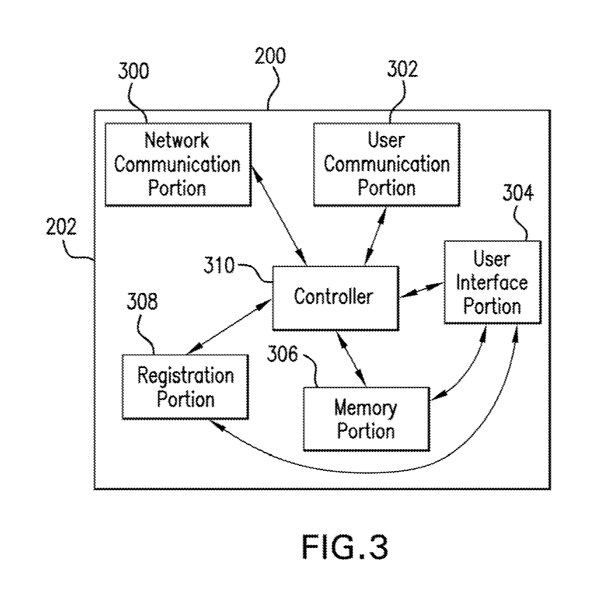

FIG. 3 illustrates an exploded view of an example CCMS 202 of FIG. 2.

As shown in FIG. 3, CCMS 202 includes a controller portion 310, a network communication portion 300, a device communication portion 302, a user interface portion 304, a memory portion 306 and a registration portion 308.

Controller 310 is operable to communicate with network communication portion 300, device communication portion 302, user interface portion 304, memory portion 306 and registration portion 308. User interface portion 304 is operable to communicate with memory 306 and registration portion 308.

Controller 310 controls interactions between the individual portions of CCMS 202. Controller 310 analyzes information provided to it by network communication portion 300, device communication portion 302, user interface portion 304, memory portion 306 and registration portion 308 and determines actions that should be taken based on the information provided.

Network communication portion 300 is operable to communicate with communication network 102 and provide controller 310 information regarding communications with communication network 102.

Device communication portion 302 is operable to communicate with devices 124-136 and 114 and provide controller 310 information regarding communications between devices 124-136.

User interface portion 304 is operable to communicate with users 110, 112 and 114. Users 110, 112 and 114 input information regarding their profiles to user interface portion 304, and user interface portion 304 may provide feedback to users 110, 112 and 114 regarding the information. Information may include the addition of user contacts, grouping of the user contacts into specific groups, availability of the user to receive calls from other registered users, or any other information that may be useful in streamlining the communication process for the user. Users 110, 112 and 114 can input information into user interface portion 304 via mobile phone, satellite phone, the Internet, etc.

Memory portion 306 is operable to save information provided via user interface portion 304, and provide controller 310 access to the information

Registration portion 308 is operable to receive information provided to user interface portion 304. During the registration process, the user will upload information to user interface portion 308 using a mobile device or computer. Registration information generated during the registration process is accessible to controller 310. This upload may be considered a registration communication.

For example, registration portion 308 may include a lookup table that includes numerous data portions. One data portion, for example, may include a user ID and password that is chosen by the user during the registration process. The user ID is a unique identifier assigned to each registered user. It is used by the user to update or modify information entered during the initial registration process.

A second data portion may include all the contact information the user would like to associate with the user ID. For example, the user may register home, office and mobile phone numbers, personal and work e-mail addresses, web sites, and any other manner by which the user wishes to be contacted.

A third data portion may include preferences for access to the telephone numbers. For example, if the user registers three telephone numbers, access to telephone number 1 may be limited to family members, access to telephone number 2 may be limited to friends, and access to telephone number 3 may be limited to co-workers.

A fourth data portion may include preferences for what action to take if the user is not available or does not answer a phone call. Preferences may include forwarding a phone call to a different number, forwarding a phone call to a voice mail system, or automatically sending a text message as a notification that the user is currently unavailable.

A fifth data portion may include the daily calendar of the user. Access to the calendar is provided to registration portion 308 by the user, and the calendar may be synchronized with registration portion 308 as specified by the user (i.e., daily, or whenever the calendar is modified).

A sixth data portion may include the communication route based on the context of a call. For example, depending on the caller, the user's location, the user's availability, the time, the caller's device, the user's device being called, the type of communication (voice, video, text, etc.), or even based on the urgency of the communication (which could be provided by the caller), the user may be able to input a specific “route” which will be the best way to be reached. For example, the user may indicate that all voice calls are forwarded to a cell phone, whereas all image and video data are forwarded to the user's portable tablet device.

The data portions discussed above are non-limiting examples, the information input during the user's registration process may include other data portions.

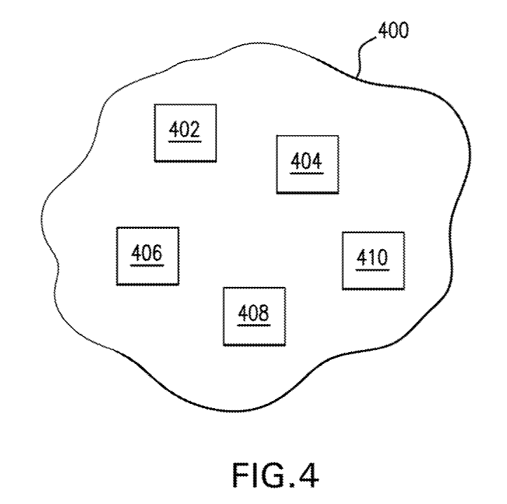

FIG. 4 illustrates user 400 that communicates via CCMS 202 of FIG. 2.

As shown in FIG. 4, user 400 possesses a plurality of connection devices 402-410 that can access communication networks 100 of FIG. 2 via CCMS 202 of FIG. 3.

Devices 402-410 may include land-line telephones, cellular telephones, satellite telephones, pagers, computers, or other devices that can be used for communication. User 400 may add or delete communication devices from his user profile by communicating the changes to CCMS 202.

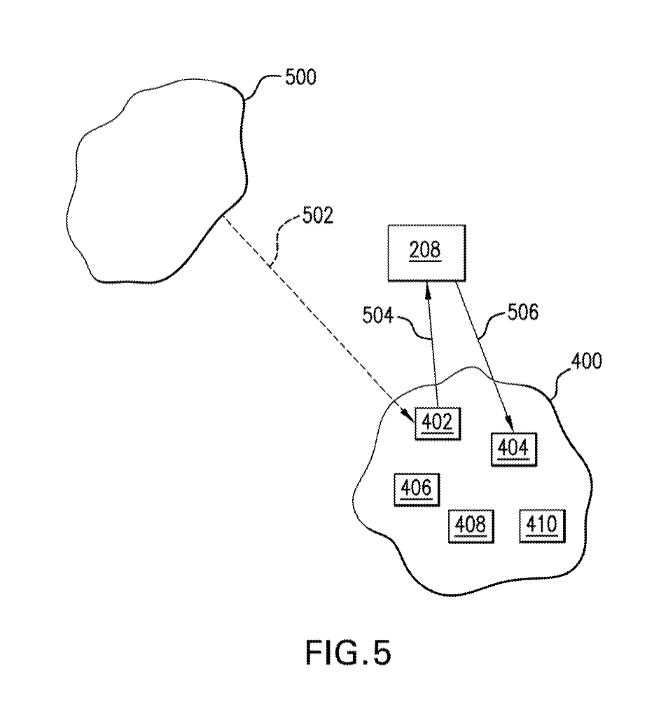

FIG. 5 illustrates an attempt by user 500 to open a connection with user 400 of FIG. 4

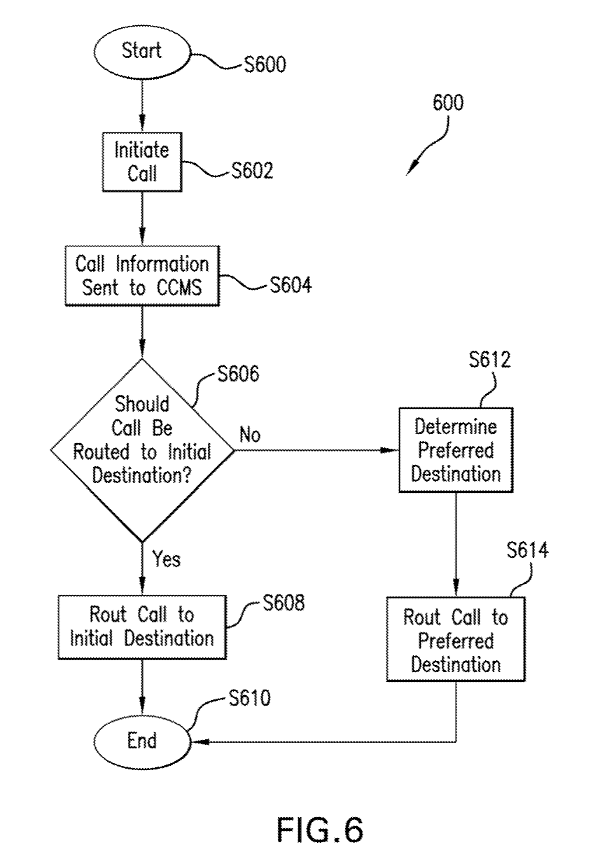

As shown in FIG. 5, user 500 attempts to connect to device 402 via communication channel 502. Device 402 routes the attempted call through CCMS 202 via communication channel 504, which then routes the call to device 404 via communication channel 506. This process will be further described with reference to FIG. 6.

FIG. 6 illustrates a process 600 by which CCMS 202 of FIG. 3 determines how to rout an attempt to open the connection of FIG. 5.

Returning to FIG. 5, process 600 starts (S600) and a phone call is initiated by user 500 (S602). The phone call initiated by user 500 is sent to device 402 of user 400 via communication channel 502. The call may originate from a land line phone, mobile phone, satellite phone or other communication device.

It can also be appreciated that the attempt to connect to user 400 may not involve a phone. Connection attempts may be made via email or other connection method, but for purposes of brevity the process will be described as a phone call. The same process would apply if an alternative connection method were employed.

Returning to FIG. 5, device 402 receives the call from user 500, and routes the incoming call information to CCMS 202 (S604) via communication channel 504.

Returning to FIG. 3, the incoming call information sent via communication channel 504 is received by device communication portion 302. Device communication portion 302 sends the incoming call information to controller 310.

Controller 310 then forwards incoming call information to memory portion 306. Memory portion 306 evaluates the preferences of user 400 (which were entered via user interface portion 304 and stored in memory portion 306) to determine if device 402 is the preferred destination for a call initiated from user 500, or if one of devices 404-410 is the preferred device.

If memory portion 306 determines that device 402 is the preferred destination for a call initiated by user 500, memory 306 forwards that information to controller 310. Controller 310 then instructs device communication portion 302 to route the call to device 402 (S608) and process 600 ends (S610).

If memory portion 306 determines that device 402 is not the preferred destination for a call initiated by user 500, memory 306 determines the preferred destination (S612) and forwards that information to controller 310. In this example, the preferred destination for a call to user 400 that is initiated by user 500 is device 404. Controller 310 then instructs device communication portion 302 to route the call to device 404 (S614).

Returning to FIG. 5, the call is routed to device 404 via communication channel 506, and process 600 ends (S610).

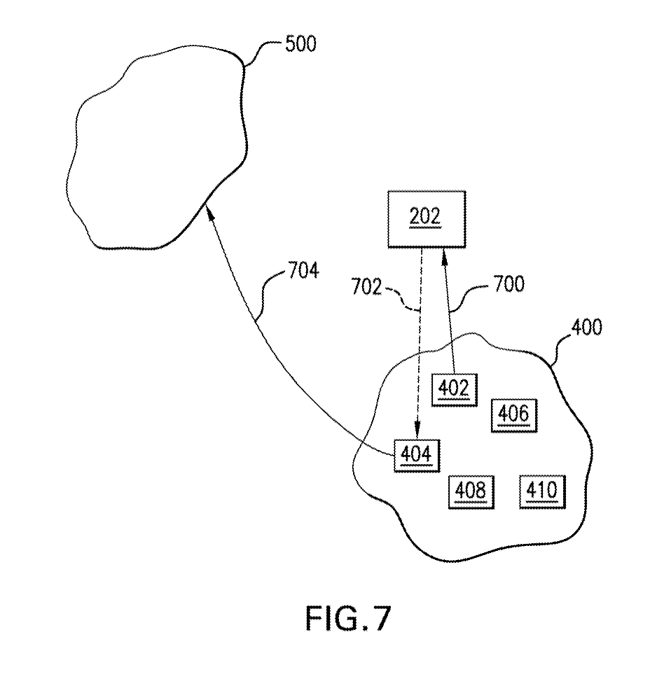

FIG. 7 illustrates an attempt by user 400 of FIG. 4 to open a connection with user 500 of FIG. 5.

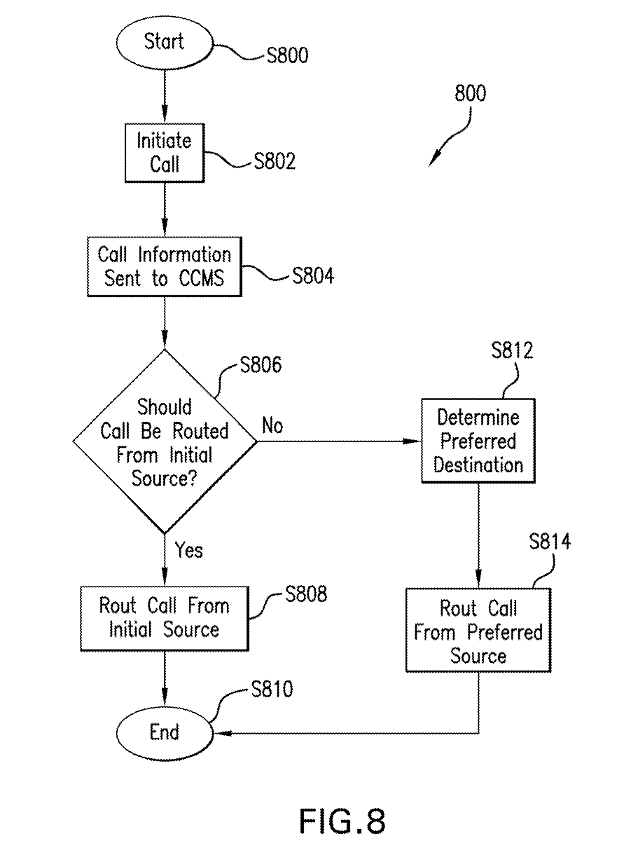

As shown in FIG. 7, user 400 attempts to call user 500 via device 402. Device 402 routes the attempted call information through CCMS 202 via communication channel 700. CCMS 202 then routes the outgoing call through device 404 via communication channel 702, and user 500 sees the incoming call as though it was placed from device 404 via communication channel 704. This process will be further described with reference to FIG. 8.

FIG. 8 illustrates a process 800 by which the CCMS 202 of FIG. 3 determines how to route an attempt to open the connection of FIG. 7.

Returning to FIG. 7, process 800 starts (S800) when user 400 initiates a call to user 500 (S802) that originates from device 402 via communication channel 700. The call may originate from a land line, mobile phone, satellite phone or other communication device.

The attempt to connect to user 500 may not require a phone. Connection attempts may be made via email or other connection method; the process will be described as a phone call. The same process would apply if some other connection method were employed.

Returning to FIG. 7, communication channel 700 sends the call information to CCMS 202 (S804).

CCMS 202 must determine if the call should be routed from device 402 (S806), or if another device is the preferred device for the origination of a call from user 400 to user 500.

Returning to FIG. 3, call information is received by device communication portion 302 of CCMS 202. Device communication portion 302 then sends the call information to controller 310.

Controller 310 then forwards the call information to memory portion 306. Memory portion 306 evaluates the preferences of user 400 (which were entered via user interface portion 304 and stored in memory portion 306) to determine if device 402 is the preferred source for a call to user 500.

If memory portion 306 determines that device 402 is the preferred source for a call to user 500, memory 306 forwards that information to controller 310. Controller 310 then instructs device communication portion 302 to route the call through device 402 (S808) and process 800 ends (S810).

If memory portion 306 determines that device 402 is not the preferred source for a call to user 500, memory 306 determines the preferred source device (S812) and forwards that information to controller 310. In this example, the preferred source for a call to user 500 that is initiated by user 400 is device 404. Controller 310 then instructs device communication portion 302 to route the call through device 404.

Returning to FIG. 7, the call is routed through device 404 (S814) via communication channel 702, then to user 500 via communication channel 704, and process 800 ends (S810).

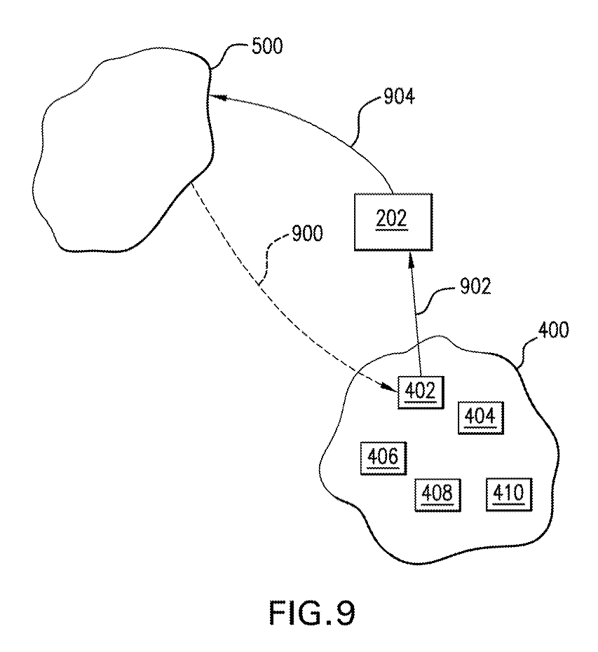

FIG. 9 illustrates an attempt by user 500 to open a connection with user 400 of FIG. 4.

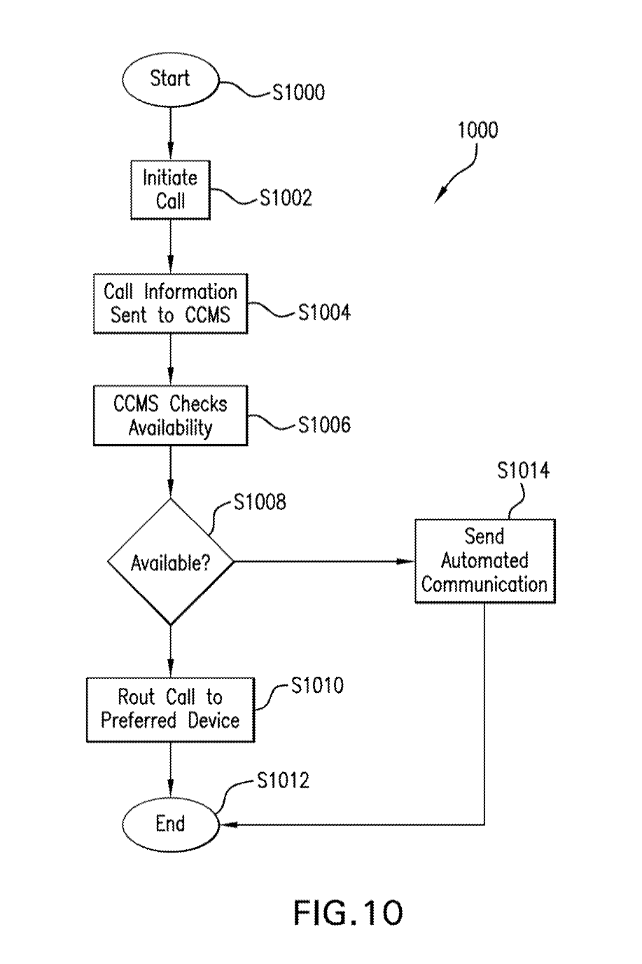

As shown in FIG. 9, user 500 attempts to connect with device 402 of user 400 via communication channel 900. Device 402 receives the connection request and routes it to CCMS 202 via communication channel 902. CCMS 202 checks the status of user 400 and learns that user 400 is currently unavailable. CCMS 202 then sends an automatic reply to user 500 via communication channel 904. This process will be further described with reference to FIG. 10.

FIG. 10 illustrates a process 1000 by which the CCMS 202 of FIG. 3 checks the availability of a user.

Returning to FIG. 9, process 1000 starts (S1000) when a call is initiated by user 500 (S1002). The call is directed to device 402 of user 400 via communication channel 900.

It can also be appreciated that the attempt to connect to user 400 may not require a phone. Connection attempts may be made via email or other connection method, but for illustrative purposes the process will be described as a phone call. The same process would apply if an alternative connection method, a facsimile machine for example, were employed.

Returning to FIG. 9, device 402 receives the call from user 500, and routes the incoming call information to CCMS 202 (S1004) via communication channel 902.

CCMS 202 needs to determine if user 400 is available to receive a call from user 500 (S1006).

Returning to FIG. 3, the incoming call information sent via communication channel 902 is received by device communication portion 302. Device communication portion 302 sends the incoming call information to controller 310.

Controller 310 then forwards incoming call information to memory portion 306. Memory portion 306 evaluates the preferences of user 400 stored in memory portion 306 to determine if user 400 is available to receive a call initiated from user 500.

If memory portion 306 determines that user 400 is available to receive a call initiated by user 500 (S1008), memory 306 forwards that information to controller 310.

Controller 310 then instructs device communication portion 302 to route the call to device 402 (S1010) and process 1000 ends (S1012).

If memory portion 306 determines that user 400 is not available, or is unwilling, to receive calls initiated by user 500 (S1008), memory 306 forwards that information to controller 310. Memory 306 also forwards information to controller 310 regarding the preferences of user 400 and what type of automatic communication should be sent to user 500 regarding the availability of user 400. As an example, user 400 may prefer that user 500 be routed to voicemail. As another example, user 400 may prefer that user 500 receive an automated outgoing message from user 400 without the option to leave a voicemail. This message could be an outgoing voice message or a text message. As an additional example, user 400 may prefer to send an automated outgoing message that provides the option to user 500 to choose a different communication method (i.e., the outgoing message may explain to user 500 that user 400 is unavailable via voice calls, but will respond if a text message is sent). These are non-limiting examples, and other communication methods may also be employed.

Controller 310 forwards information regarding the automated response from user 400 to network communication portion 300. Network communication portion 300 then sends the automated response (S1014).

Returning to FIG. 9, the automated response is sent from user 400 to user 500 via communication channel 904. Process 1000 is then ended (S1010).

In accordance with an aspect of the present invention, any call made to one of a user's plurality of devices will be received by that person on the device of his choice, based on a predetermined routing.

In accordance with another aspect of the present invention, a user can be called by any type of ID, including an email number, a Blackberry Messenger ID or even by name.

In accordance with another aspect of the present invention, a user can transfer a call from one device to another, regardless of the technology. For example, a user may transfer a call from a landline to a cellular phone, then to a tablet.

In accordance with another aspect of the present invention, applications may be used in conjunction with the previously described aspects. For example, incoming calls may displayed on a TV, wherein the user may select on which “phone” device they are redirected. Further, a user may have multiple calls to a landline phone and tablet. The voice calls may originate on the landline, but on the other calls to the tablet may include image or video data. In accordance with the present invention, the registration portion and the controller portion would provide an ability to swap from one to the other or to add another call from the phonebook, and then merge the calls into a conference.

Regarding the difference between the present invention and a conventional call forwarding communication system, as mentioned previously, a conventional call forwarding system is independent of the context of the call: whether the caller receives no answer from the user, the line is busy, the user has no network coverage, or the user has chosen to forward all calls even though the user may be available, the call is forwarded from the device originally called to a secondary device. However, in accordance with aspects of the present invention, the forwarding depends on the context of the call: depending on the caller, a user's location, a user's availability, the time, the fact that one particular device is switched on or off (TV is on, or car phone is off), the device used, the type of communication (voice, video, text, etc.), or even based on the urgency of the communication (which could be provided by the caller), the system will be able to select one “route” which will be the best way to reach the user.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device for use with a first communication device of a first user, a second communication device of a second user, a third communication device of the second user, a communication network and a registration communication, the first communication device being operable to transmit a first communication to the third communication device by way of the communication network, the third communication device being operable to receive the first communication from the communication network, the registration communication being based on the third communication device, the third communication device being further operable to transmit the first communication, said device comprising:
a network communication portion operable to communicate with the communication network;
a device communication portion operable to communicate with the second communication device, to communicate with the third communication device, to receive the registration communication and to receive the first communication;
a registration portion operable to associate the third communication device with the second communication device based on the registration communication; and
a controller portion operable to instruct said device communication portion to transmit the first communication to the second communication device.

2. The device of claim 1, further comprising a user interface portion operable to enable the second user to interface with said controller portion.

3. A method of using a first communication device of a first user, a second communication device of a second user, a third communication device of the second user, a communication network and a registration communication, the first communication device being operable to transmit a first communication to the third communication device by way of the communication network, the third communication device being operable to receive the first communication from the communication network, the registration communication being based on the third communication device, the third communication device being further operable to transmit the first communication, said method comprising:
communicating, via a device communication portion, with the second communication device to receive the registration communication;
associating, via a registration portion, the third communication device with the second communication device based on the registration communication;
receiving, via the device communication portion, the first communication; and
instructing, via a controller portion, the device communication portion to transmit the first communication to the second communication device.

4. The method of claim 3, further comprising enabling, via a user interface portion, the second user to interface with the controller portion.

5. A non-transitory, tangible, computer-readable media having computer-readable instructions stored thereon, the computer-readable instructions being capable of being read by a computer to be used with a first communication device of a first user, a second communication device of a second user, a third communication device of the second user, a communication network and a registration communication, the first communication device being operable to transmit a first communication to the third communication device by way of the communication network, the third communication device being operable to receive the first communication from the communication network, the registration communication being based on the third communication device, the third communication device being further operable to transmit the first communication, the computer-readable instructions being capable of instructing the computer to perform the method comprising:
communicating, via a device communication portion, with the second communication device to receive the registration communication;
associating, via a registration portion, the third communication device with the second communication device based on the registration communication;
receiving, via the device communication portion, the first communication; and
instructing, via a controller portion, the device communication portion to transmit the first communication to the second communication device.

6. The non-transitory, tangible, computer-readable media of claim 1, the computer-readable instructions being capable of instructing the computer to perform said method further comprising enabling, via a user interface portion, the second user to interface with the controller portion.
